(19) United States
(12) Patent Application Publication
(10) Pub. No.: US 2017/0121122 A1
(43) Pub. Date: May 4, 2017

(54) DEVICE FOR UNILATERAL ANALYSIS OF PRODUCTS BY TURNING AND AUTOMATIC SORTING AND CONVEYING DEVICE INCORPORATING SAME

(71) Applicant: MAF AGROBOTIC, Montauban (FR)

(72) Inventor: Philippe BLANC, Montauban (FR)

(73) Assignee: MAF AGROBOTIC, Montauban (FR)

(21) Appl. No.: 15/307,656

(22) PCT Filed: Apr. 28, 2015
(86) PCT No.: PCT/EP2015/059213

§ 371 Date: Oct. 28, 2016

(30) Foreign Application Priority Data
Apr. 30, 2014 (FR) 1453965

(51) Int. Cl. B65G 47/248; B07C 5/36; B07C 5/342

(52) U.S. Cl. CPC B65G 47/248; B07C 5/342; B07C 5/36; B07C 2501/009; B65G 2201/0211

(57) ABSTRACT

The invention relates to a device for unilateral analysis—notably optical—of products comprising a product turning device comprising two series (18, 20) of levers (19, 21) in opposition borne by at least one conveyor continuously driven in a longitudinal direction with respect to a fixed structure, and a device (34, 37) controlling the tilting of the levers (19, 21) arranged to cause the products to be turned over in a turning zone (35) between two successive unilateral analysis work stations in the longitudinal direction. In the turning zone, several levers (19, 21) of one same series are caused to tilt by the control device (34, 37), each product being able to be turned over under the effect of the tilting of several levers (19, 21) of each series.

The invention relates to a device for unilateral analysis—notably optical—of products (in particular bulky products and/or elongate products (non-planar, i.e. having shapes other than that of a plate), such as fruit or vegetables, e.g. pears, potatoes, carrots, avocados, tomatoes, peaches, cucumbers . . . ) comprising a product turning device between two successive—notably optical—unilateral analysis work stations. The invention relates to a device for automatically sorting and conveying products comprising such a device for unilateral analysis—notably optical—of the products and a device for sorting the products in accordance with predetermined selection criteria and based on product analysis signals output notably by the—notably optical—unilateral analysis device.

Throughout the text, the term “unilateral analysis device” is understood to mean any analysis device which is arranged next to a product to be analysed, and allows an analysis, the result of which depends on the orientation of the product with respect to the analysis device (receiver or sensor such as a camera). The optical analysis (including infrared, ultraviolet and visible domain) is often a unilateral analysis (optical analysis by reflection, imagery, colorimetry, shadow contour optical analysis . . . ), with only the side of the product seen by the optical analysis device being analysed, the other side of the product, opposite the analysis device, not being analysed.

The optical analysis of the products for automatic sorting of same supposes the ability to optically investigate the products (notably taking images, spectrometry . . . ) from across the entire outer surface of each product. To this end, there are known automatic sorting devices comprising a product conveying device comprising product support rollers and a device for rotationally driving the products borne by the rollers (cf. notably FR 2874425).

With these known devices, there is no need to provide multiple optical analysis devices (at the different analysis angles required). It should be noted in this regard that, in practice, it is not possible to provide optical analysis devices located beneath the conveying device, even if the latter could be adapted to allow optical analysis from below. In fact, in addition to the associated costs, optical analysis of products such as fruit or vegetables from below is not compatible with design requirements for the conveying device, and inevitably quickly becomes inoperable following the inevitable contamination of an optical analysis device which would be located beneath the conveying device.

The known devices mentioned above suppose the ability to cause the products to rotate about themselves between the—notably optical—unilateral analysis work stations, which is not always possible, notably in the case of products which are not completely spherical (pears, avocados, elongate vegetables . . . ) and in the case of particularly fragile products (ripe pears, eggs, ripe peaches, tomatoes, . . . ). It should be noted in particular that in the case of products which have a winding and variable shape, such as pears, it is also very difficult to control the orientation of each product with respect to the conveying device. In particular, it is virtually impossible to determine the position and orientation of the stalk of a fruit such as a pear. Therefore, numerous faults are likely to be present with respect to the stalk of the fruit which should thus be the subject of a particularly precise—notably optical—unilateral analysis.

EP 993877 describes a product turning device formed with two support levers delimiting therebetween a space for holding a product and simultaneously tilting to remove a product from a conveyor and place it on another conveyor after being turned over. This turning device is also limited to products having relatively constant and similar shapes, orientation and sizes, corresponding to the shapes and dimensions of the holding space delimited between the two support levers, the shapes and dimensions of which are adapted to this end. However, the—notably optical—unilateral analysis of the products takes place prior to sorting same, and therefore the products which are fed by a conveyor to—notably optical—unilateral analysis work stations can have extremely diverse shapes, sizes and orientations. Consequently, such a turning device with two tilting levers is not used in practice. Furthermore, this turning device requires that the position and tilting of levers be perfectly synchronised with the conveyors transporting the products. In other words, this turning device is synchronous. Likewise, this turning device causes each product to be turned over relatively forcefully, with a relative displacement of the contact surface of each lever with respect to that of the products as they are turned over. It is thus not adapted to products with unknown dimensions and shapes and/or very fragile products such as ripe pears, avocados, eggs or ripe peaches . . .

The invention thus aims to overcome these disadvantages.

The invention thus aims to propose a device for unilateral analysis—notably optical—of products comprising a turning device which can be used, in practice, to turn over products which have variable shapes (products which are bulky, completely spherical or non-spherical and non-planar, notably elongate) and/or dimensions (size) and/or orientation, or even any shape/dimension/orientation.

The invention likewise aims to propose such a device for unilateral analysis—notably optical—comprising a turning device which can be used, in practice, to turn over products which have shapes (products which are bulky, completely spherical or non-spherical and non-planar, notably elongate) and/or dimensions (size) and/or orientation which are not previously determined or known with precision.

The invention likewise aims to propose such a device for unilateral analysis—notably optical—which can be used with particularly fragile products such as pears, avocados, peaches, tomatoes, eggs or other similar products.

The invention likewise aims to propose such a device for unilateral analysis—notably optical—which can be used in practice in an asynchronous manner, i.e. with any type of conveying device, with the spacing between the different products supplying the—notably optical—unilateral analysis device not necessarily being controlled.

The invention likewise aims to propose such a device which is compatible with use in an agricultural environment and on an industrial scale.

To this end, the invention relates to a device for unilateral analysis—notably optical—of products comprising a product turning device comprising two series of tilting levers in opposition borne by—notably articulated with respect to—at least one conveyor driven in a longitudinal direction with respect to a fixed structure, and a device for controlling the tilting of the tilting levers arranged to cause the products to be turned over in a turning zone between two successive—notably optical—unilateral analysis work stations in the longitudinal direction,

characterised in that the tilting levers of each series are arranged with respect to each other such that in the turning zone several tilting levers of one same series are caused to tilt by the control device, each product being able to be turned over under the effect of the tilting of several tilting levers of each series, and in that the device for controlling the tilting is arranged to cause progressive tilting of the tilting levers of each series, at least in the turning direction of a product.

In practice, the fact that each product is turned over in the turning zone under the effect of the progressive tilting of several tilting levers allows in fact the shape and dimensions of the tilting levers to not necessarily be defined as a function of the shape and dimensions of the products which are not known in advance. Furthermore, the position of the tilting levers and the tilting thereof can be completely desynchronised with each conveyor transporting the products upstream and/or downstream of the—notably optical—unilateral analysis device. Likewise, since each product is gripped and turned over under the effect of the progressive tilting of several tilting levers on each side, it is possible to provide and adapt a device in accordance with the invention to very fragile products.

The two series of tilting levers are in opposition, and are thus adapted to be able to receive and grip the products therebetween, the tilting levers of one series of tilting levers being on one side of the products and the tilting levers of the other series of tilting levers being on the other side of the products.

Therefore, in a device in accordance with the invention, the levers of each series are arranged with respect to each other and the device for controlling the tilting is arranged such that in the turning zone several levers of each series are caused to progressively tilt by the control device.

In a device in accordance with the invention, the tilting kinematics of different tilting levers of each series can be varied, notably with respect to the drive kinematics of each conveyor. For example, the tilting levers can be tilted in groups. Nevertheless, advantageously and in accordance with the invention, the device for controlling the tilting is arranged to cause progressive tilting of the tilting levers of each series, at least in the turning direction of a product. Preferably, each conveyor is continuously driven with respect to the structure. Therefore, the product is turned over in an extremely progressive manner, in the manner of a caterpillar track, and without any risk of impacts. Preferably, the device for controlling the tilting is also arranged to cause progressive tilting of the tilting levers of each series in the return direction of the tilting levers to the initial position after turning over a product. Advantageously and in accordance with the invention, this progressive tilting is ensured by ramps of the device for controlling the tilting fixed to the structure of the device in accordance with the invention and cooperating with each of the tilting levers successively during their movement in the longitudinal direction.

Furthermore, a device in accordance with the invention is also characterised in that the tilting levers of each series are arranged with respect to each other such that each product can be supported by several tilting levers of one same series, said levers being successive in the longitudinal direction. In particular, advantageously and in accordance with the invention, the tilting levers of each series of levers are spaced apart from each other in the longitudinal direction by a distance smaller than the smallest dimension of the products such that each product is supported (before and after the turning zone) by at least two successive tilting levers of one same series of tilting levers.

Furthermore, advantageously and in accordance with the invention, the tilting levers of each series are articulated in articulation axes oriented in the turning zone in parallel with the longitudinal direction. Therefore, the tilting of the tilting levers and the turning over of the products are effected by pivoting about an axis in parallel with the longitudinal direction. It should be noted that other arrangements would be possible, for example with axes slightly inclined with respect to the longitudinal direction.

Furthermore, advantageously and in accordance with the invention, the tilting levers of each series are articulated in articulation axes which are coincident with each other in the turning zone.

In one particularly advantageous embodiment and in accordance with the invention, the tilting levers of the two series are articulated on common supports of one same conveyor bearing and driving the two series of tilting levers. Advantageously and in accordance with the invention, the tilting levers of the two series are mutually nested individually or by group, i.e. are arranged alternatively in the longitudinal direction of one same conveyor.

Furthermore, advantageously and in accordance with the invention, the tilting levers of the two series are articulated in articulation axes which are coincident with each other in the turning zone. In this manner, the tilting kinematics of the tilting levers is particularly simple and reliable and does not cause any friction of the tilting levers on the outer surface of the products as they are turned over.

Advantageously and in accordance with the invention, at least in the turning zone the tilting levers form the only members for transporting the products. In particular, a device in accordance with the invention does not require the products to be supplied by a roller conveyor or a biconical conveyor.

Furthermore, the shape which can be given to each tilting lever can be the subject of different embodiment variants. Advantageously and in accordance with the invention, each tilting lever forms a transverse support finger for the products. Therefore, each tilting lever is not able to support a product by itself and it is the multiplicity of successive tilting levers in the form of conveying fingers which allows each of the products to be supported. In this manner, the device in accordance with the invention is able to receive products of any type, any shape and any dimension, said products being compatible with the succession of tilting levers forming the conveying fingers of each series, and the device ensures optimum support for each product in all circumstances.

In one preferential embodiment, advantageously and in accordance with the invention, each tilting lever comprises:
a transverse finger having an upper support face for the products and a lower face cooperating with a ramp, named a turning/gripping ramp of the device for controlling the tilting, said lower face and said turning/gripping ramp being arranged to lift and tilt said transverse finger—during the longitudinal movement of the tilting lever in the turning zone—from a support position for the products to a turning/gripping position for the products,
and a heel cooperating with a ramp, named an opening/turning ramp of the device for controlling the tilting, the heel and said opening/turning ramp being arranged to lift and tilt said transverse finger—during the longitudinal movement of the lever in the turning zone—from a turning/gripping position for the products to a support position for the products.

A device in accordance with the invention thus allows the execution of the unilateral analysis—notably optical—of products of any shape and dimensions, including elongate or twisted shapes (such as for example potatoes), by taking for example images of all of the length of the products, over all of their outer surface, including the thin ends which are likely to have the most flaws.

The invention likewise relates to a device for automatically sorting and conveying products comprising a device for unilateral analysis—notably optical—of the products and a device for sorting the products in accordance with predetermined selection criteria and based on signals output by the device for unilateral analysis—notably optical—of the products, characterised in that it comprises a device for unilateral analysis—notably optical—of the products in accordance with the invention. An automatic sorting and conveying device in accordance with the invention can likewise incorporate other devices for analysing products, e.g. a weighing device.

In one particularly advantageous embodiment and in accordance with the invention, the device for unilateral analysis—notably optical—of the products supplies a sorting conveyor suitable for receiving the products delivered by the turning device and comprising supports for the products, as well as means for selectively unloading the products in a selected unloading zone from among a plurality of unloading zones by a control unit based on said selection criteria and signals output by the different analysis devices. This sorting conveyor can be, for example, a conveyor with tilting conveying fingers as described for example in EP 810963. It should be noted that in this case it is sufficient for the distance between the sorting conveyor conveying fingers to be a multiple of the distance separating the successive levers of the series of levers of the turning device cooperating with these conveying fingers.

The invention likewise relates to a device for unilateral analysis—notably optical—of products as well as a device for automatic sorting and conveying of products, characterised in combination by all or some of the features mentioned above or hereinafter.

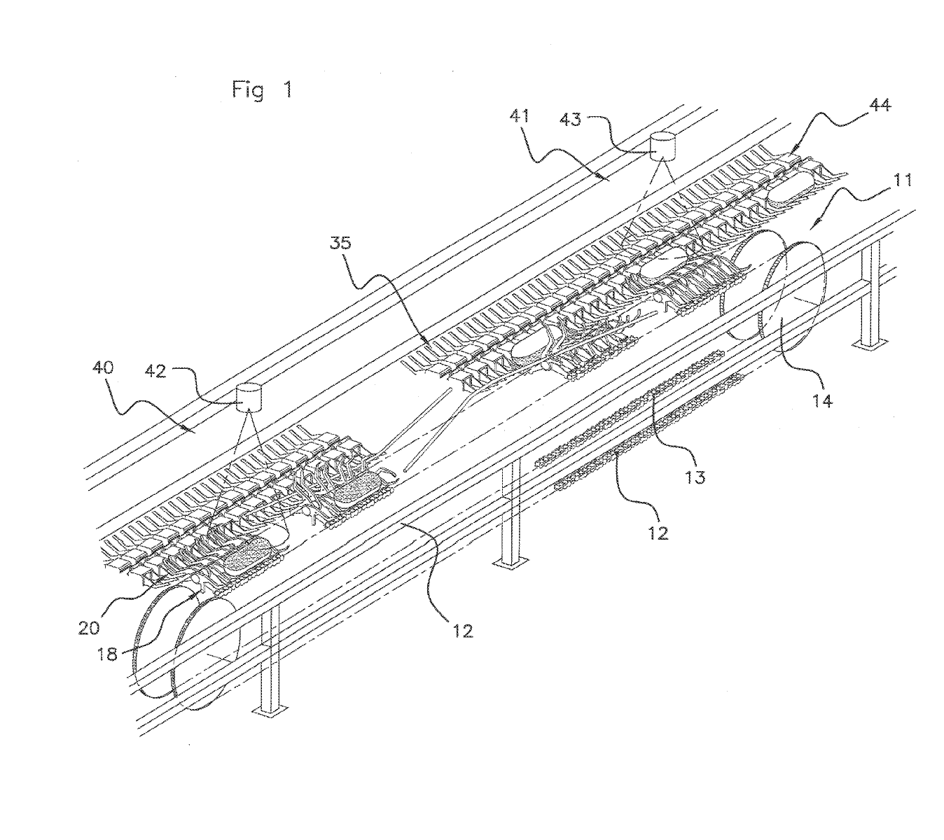

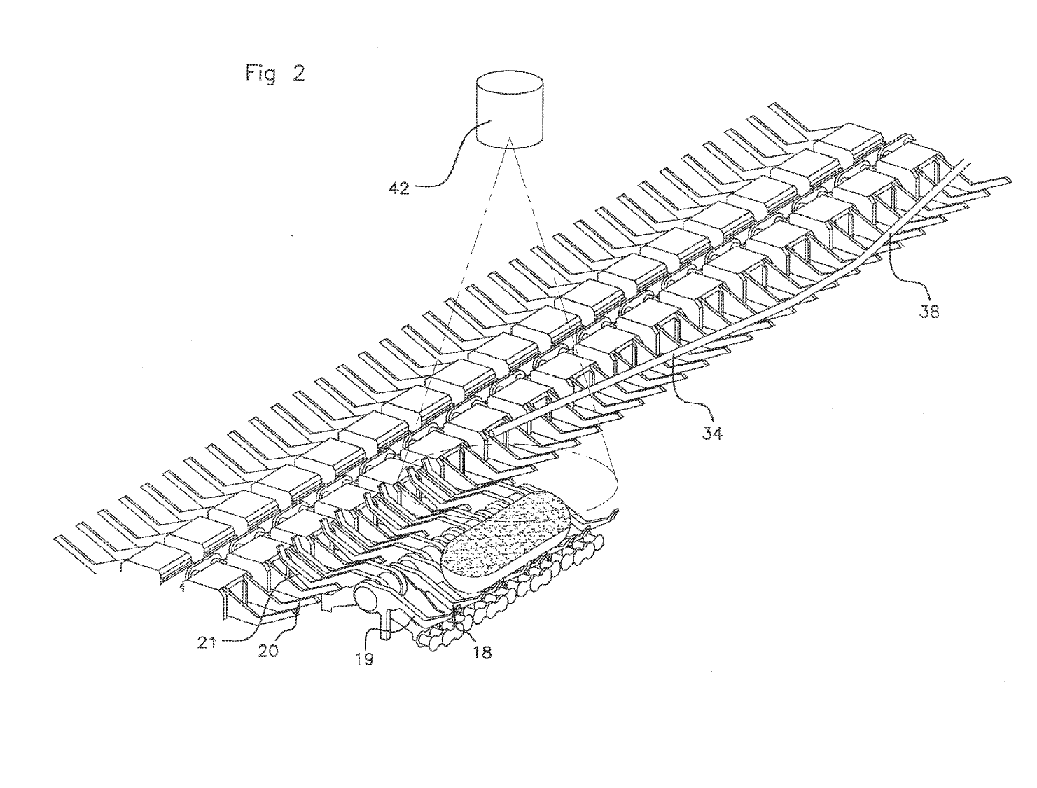

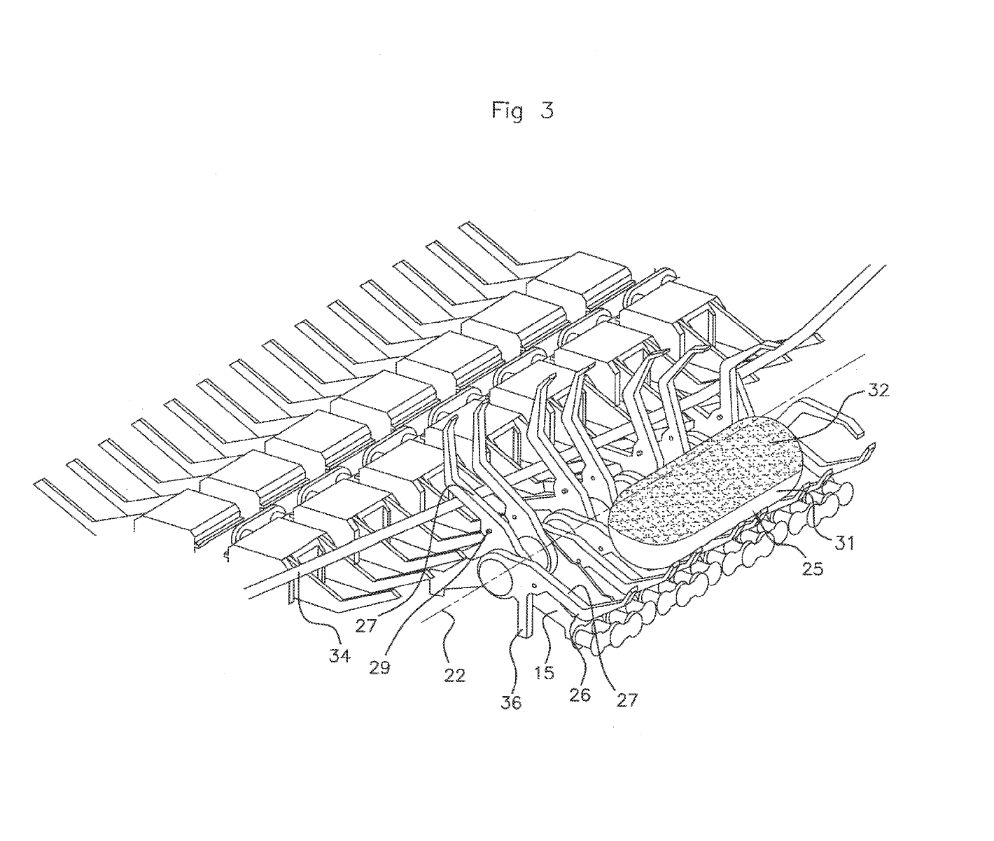

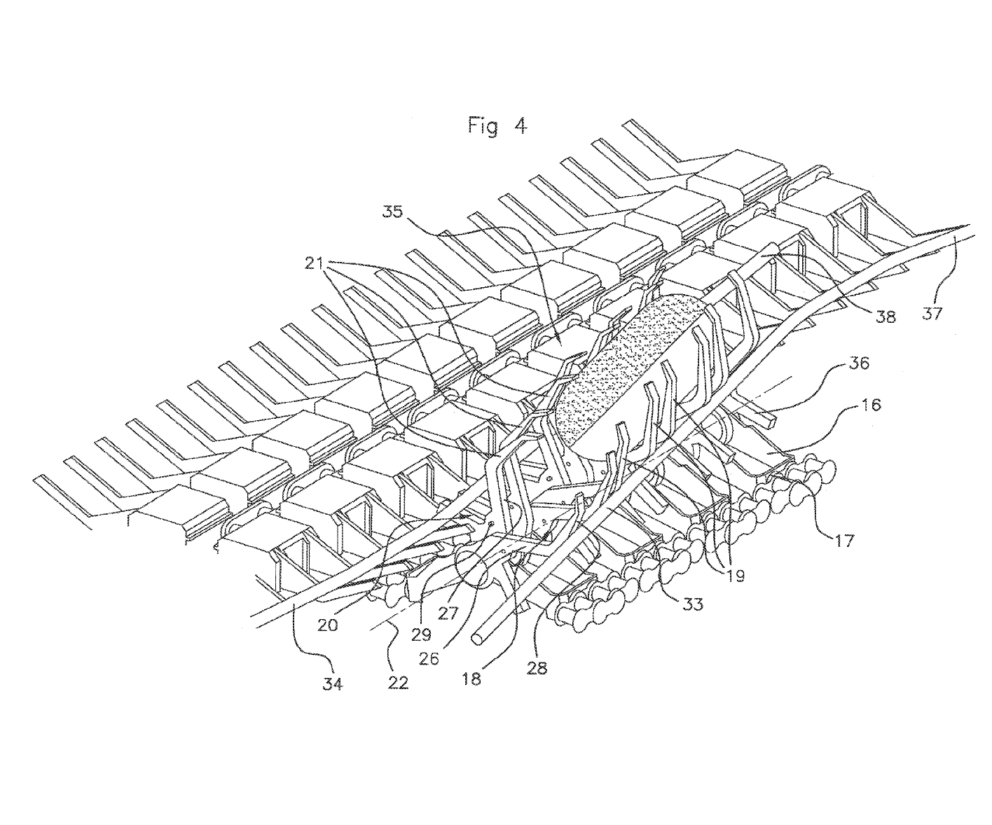

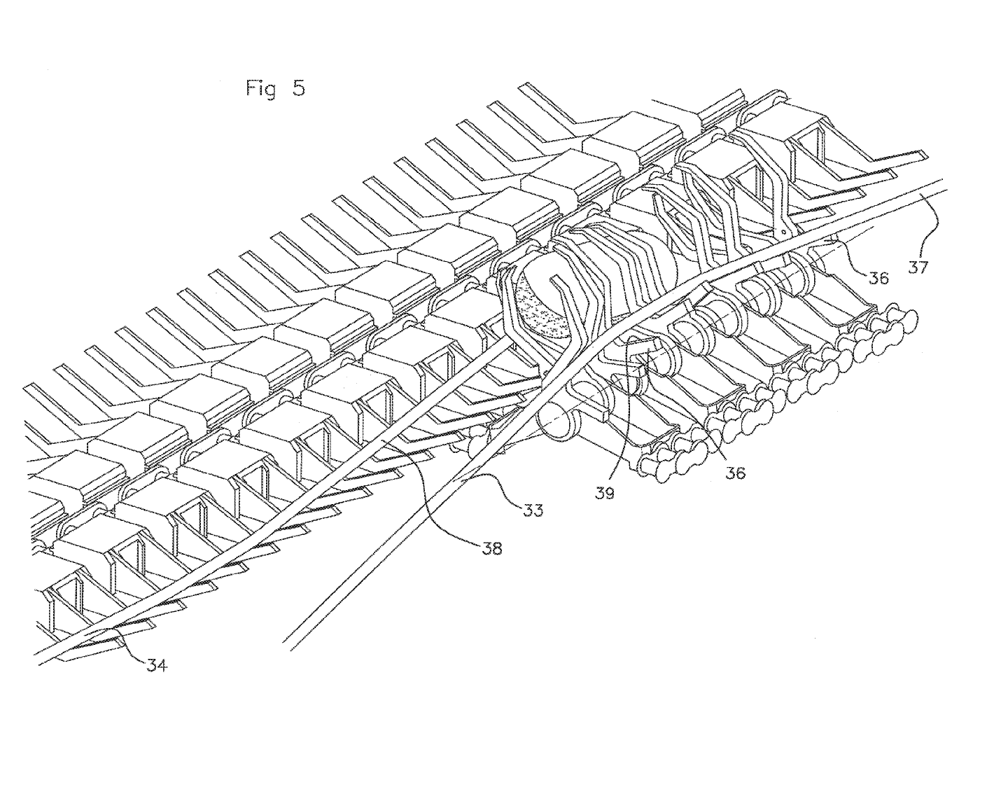

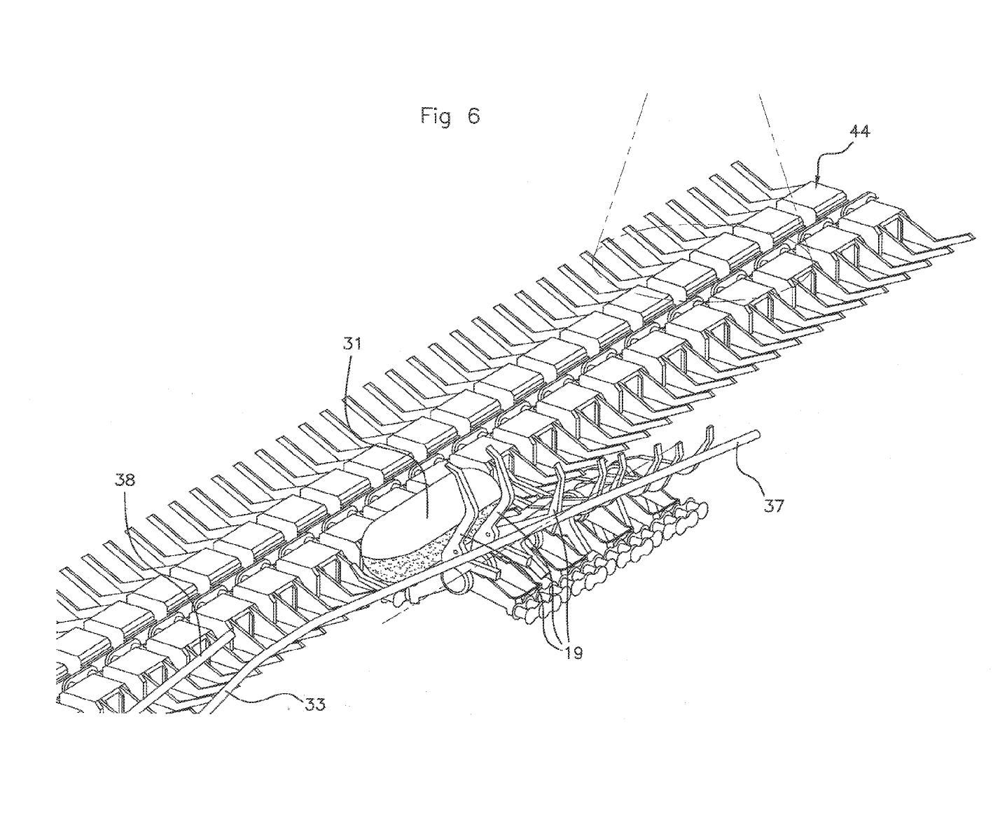

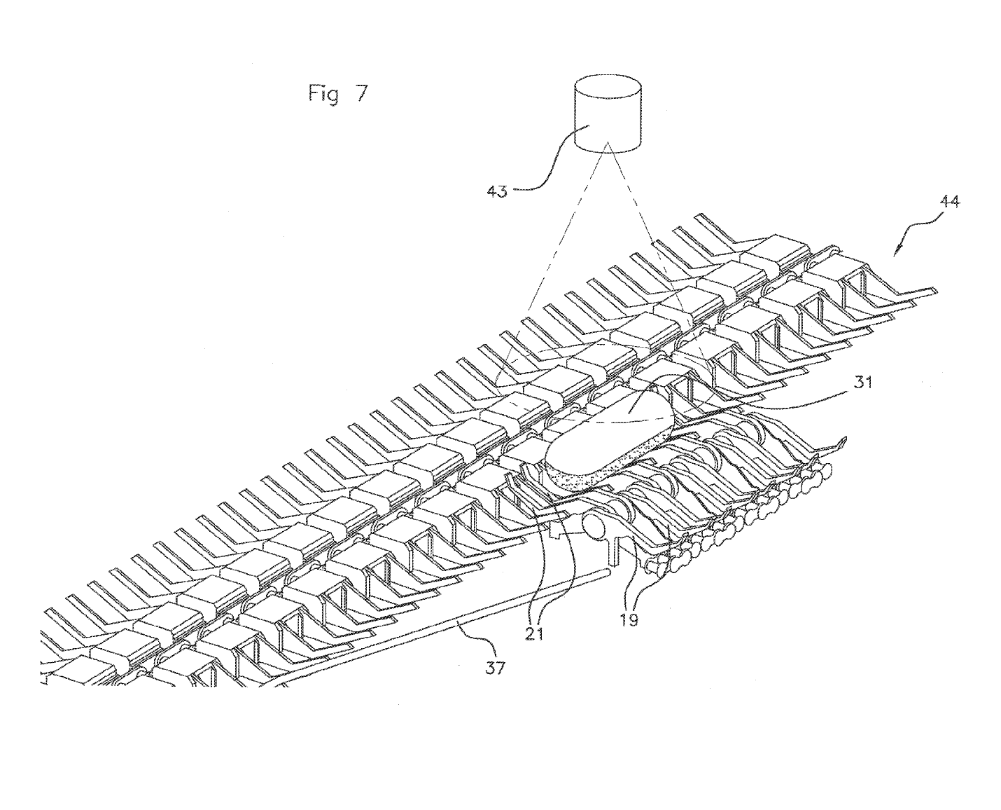

Other aims, features and advantages of the invention will become apparent upon reading the following description of an exemplified embodiment of a device for optical analysis of products in accordance with the invention, given by way of non-limiting example, and referring to the attached figures in which:
FIG. 1 is a schematic, partially perspective view of a device for optical analysis of products in accordance with the invention (the ramps controlling the turning are not shown for ease of clarity),
FIG. 2 is a schematic, partially perspective view showing a first part of the device of FIG. 1, in which a product resting on the tilting levers of a first series of tilting levers of the turning device is subjected to a first optical analysis,
FIG. 3 is a schematic, partially perspective view showing a second part of the device of FIG. 1, in which levers of a second series of tilting levers of the turning device are tilted so as to grip a product,
FIG. 4 is a schematic, partially perspective view showing a third part of the device of FIG. 1, in which the tilting levers of the two series of tilting levers of the turning device are at the start of the tilting process so as to turn over a product,
FIG. 5 is a schematic, partially perspective view showing a fourth part of the device of FIG. 1, in which the tilting levers of the two series of tilting levers of the turning device are at the end of the tilting process so as to turn over a product,
FIG. 6 is a schematic, partially perspective view showing a fifth part of the device of FIG. 1, in which the turned over product is supported by the tilting levers of the second series of tilting levers of the turning device, and the tilting levers of the first series of tilting levers of the turning device are in the process of tilting to return to their initial position for supporting another product,
FIG. 7 is a schematic, partially perspective view showing a sixth part of the device of FIG. 1, in which a product resting on the tilting levers of the second series of tilting levers of the turning device is subjected to a second optical analysis.

A device for the optical analysis of products in accordance with the invention, as shown in the figures, comprises a turning conveyor 11 which, in the example, comprises two continuous belts 12, 13 with parallel loops continuously driven in synchronism (in the direction of the arrow shown in FIG. 1) by pinions 14 rotationally mounted with respect to a fixed structure 30, at least one of the belts being driven by a motor (not shown).

The two belts 12, 13 form a horizontal carrying side and bear and drive supports 15 bearing two series 18, 20 of tilting levers 19, 21 in opposition. The supports 15 are formed by carriers 16 extending, at the height of the carrying side, above the belts 12. The carriers 16 are in the form of frames fixed by each of their transverse ends to two link pins of each of the belts 12 by two bolts 17. In this manner, the carriers 16 are driven and oriented by the links of the belts 12. Each carrier 16 forms two supports 15 extending between the two belts 12 and being successive and adjacent in the longitudinal direction. Each support 15 bears in its centre (between the two belts 12) two tilting levers 19, 21 which are freely articulated to the support 15 about one same axis 22 in parallel with the longitudinal direction of the belts 12.

A first lever 19 articulated to a support 15 belongs to a first series 18 of identical tilting levers articulated on successive supports 15 along the conveyor 11, these levers 19 of the first series 18 extending towards the first belt 12 when they are in position to support a first face 31 of products resting on these levers 19 of this first series 18. A second lever 21 articulated to the support 15 belongs to a second series 20 of identical tilting levers articulated on successive supports 15 along the conveyor 11, these levers 21 of the second series 20 extending towards the second belt 13 when they are in position to support a second face 32 of products, opposite said first face 31, resting on these levers 21 of this second series 20.

Each tilting lever 19, 21 comprises a transverse finger 26 extending radially to the axis 22 and having an upper face 27 for supporting the products and a lower face 28 arranged to be able to cooperate with a ramp for controlling tilting, as described in more detail hereinafter.

The finger 26 has a stop lug 29 arranged to cooperate with the support 15 for limiting downwards rotation, against the force of gravity, of the lever 19, 21 with the finger 26 in the substantially horizontal support position for a product resting on the upper face of the finger 26.

Each lever 19, 21 of a series 18, 20 can, in a turning zone 35 of the conveyor 11, be tilted upwards by rotation about the axis 22 from the support position for the products to a turning/gripping position for the products above the levers 21, 19 of the other series 20, 18. To this end, the lower face 28 of the finger 26 is suitable for cooperating with a ramp, named a turning/gripping ramp 33, 34, fixed to the structure 30 in the turning zone 35. Said lower face 28 and said turning/gripping ramp 33, 34 are arranged to lift and tilt said transverse finger 16—during the longitudinal movement of the lever 19, 21 in the turning zone 35—by rotation about the axis 22 towards the top and on the side, from said support position for the products to the turning/gripping position for the products. In so doing, the lower face 28 of the finger 16 slides along the turning/gripping ramp 33, 34, this latter becoming closer to the direction of the axes 22 of the supports 15. A first turning/gripping ramp 33 cooperates with the levers 19 of the first series 18 to thereby control the turn-tilting from the support position to a turning position for the products above the levers 21 of the second series 20. A second turning/gripping ramp 34 cooperates with the levers 21 of the second series 20 to thereby control the tilting from the support position to a gripping position for the products above the levers 19 of the first series 18.

Each lever 19, 21 of a series 18, 20 can, in the turning zone 35 of the conveyor 11, be tilted back by rotation about the axis 22 from the turning/gripping position for the products to the support position for the products. To this end, each lever 19, 21 comprises a heel 36 fixedly rotationally attached to the finger 16 about the axis 22 and arranged to be able to cooperate with a ramp, named an opening/turning ramp 37, 38, the heel 36 and said opening/turning ramp 37, 38 being arranged to lift and tilt said transverse finger 16—during the longitudinal movement of the lever 19, 21 in the turning zone 35—from the turning/gripping position for the products to the support position for the products. The heel 36 has a face 39 coming into contact with, and sliding on, the opening/turning ramp 37, 38.

A first opening/turning ramp 37 cooperates with the levers 19 of the first series 18 to thereby control the open-tilting from the turning position for the products to the initial support position. A second opening/turning ramp 38 cooperates with the levers 21 of the second series 20 to thereby control the product turn-tilting from the gripping position to the support position for turned over products.

The different ramps 33, 34, 37, 38 are fixed to the structures 30 and follow one another in the longitudinal direction so as to cause the products to be gripped and so as to cause the gripped products to then be turned over between a plurality of levers 19, 21 of the two series 18, 20. Travelling from upstream to downstream, the levers 19, 21 first encounter the second turning/gripping ramp 34 which tilts the levers 21 of the second series 20 into the gripping position for a product arriving in the turning zone 35. Then, the first levers 19 and the second levers 21 cooperate with the first turning/gripping ramp 33 and, respectively, with the second opening/turning ramp 38 which at least substantially face one another to cause the products to be turned over in the turning zone 35. Then, the first levers 19 cooperate with the first opening/turning ramp 37 to return these levers 19 to the support position.

The inclination of the different ramps 33, 34, 37, 38 is preferably suitable for causing progressive tilting of the levers as they are moved in the longitudinal direction, in the manner of a caterpillar track.

It should be noted that the longitudinal spacing between two successive adjacent levers 19, 21 is less than the smallest dimension of the products to be analysed by a device in accordance with the invention, such that each product is supported upstream of the turning zone 35, in the turning zone 35 and downstream of the turning zone 35 by at least two successive levers 19 or 21 of one same series 18 or 20 of levers. In the illustrated example, a product is supported by six levers 19 or 21 of each series of levers in the support position (FIGS. 1, 2, 3, 7). The number of levers supporting each product depends upon the dimension of the product, which is not known in advance. However, it is known that the products to be analysed must have a longitudinal dimension greater than a smallest predetermined dimension. This smallest predetermined dimension is, for example, 5 cm for pears, the longitudinal spacing between two successive levers 19, 21 thus being, for example, in the order of 2 to 3 cm. It should also be noted that the device in accordance with the invention allows the products to be received in any orientation whatsoever and to be turned over in order to allow the optical analysis of said products over their entire outer surface.

The device for optical analysis of products in accordance with the invention comprises at least one first optical analysis work station 40 located upstream of the turning zone 35 and at least one second optical analysis work station 41 located downstream of the turning zone 35. In the illustrated example, each optical analysis work station 40, 41 comprises an optical device mounted in a fixed manner to the structure 30, such as a camera 42, 43 arranged above the turning conveyor 11 and having a field covering an optical analysis zone for the products such that the products transported by the turning conveyor 11 pass into said field in order to be able to be analysed by the optical device.

Therefore, the first optical analysis work station 40 comprises a camera 42, the field of which covers the first levers 19 of the first series 18 of levers supporting the first face 31 of products upstream of the turning zone 35. Consequently, this first optical analysis work station 40 performs an optical analysis of the second face 32 of the products, said face being oriented upwards when the products are resting with their first face 31 on the first tilting levers 19.

The second optical analysis work station 41 comprises a camera 43, the field of which covers the second levers 21 of the second series 20 of levers supporting the second face 32 of products downstream of the turning zone 35. Consequently, this second optical analysis work station 41 performs an optical analysis of the first face 31 of the products, said face being oriented upwards when the products are resting with their second face 32 on the second tilting levers 21, after having been turned over.

Therefore, with only two successive optical analysis work stations 40, 41 whose cameras 42, 43 are located above the turning conveyor 11, it is possible to perform an optical analysis of the entire outer surface of the products.

As shown in FIG. 2, the first optical analysis work station 40 is located upstream of the second turning/gripping ramp 34 which is the ramp located closest upstream (encountered first by the levers). The second optical analysis work station 41 is located downstream of the turning zone 35 so as to perform the analysis of the products after they have been turned over. Of course, there is nothing to prevent several optical analysis work stations from being provided upstream and/or downstream of the turning zone 35, or even facing the turning zone 35. In particular, there is nothing to prevent an optical device such as a camera located above the turning zone 35 from being provided. Nevertheless, such a device for optical analysis of products as they are turned over is generally not useful in the sense that it is relatively complex to process the optical analysis signals or images provided thereby (since the precise orientation of the products in this turning zone 35 is not controlled and may vary from one product to another) and is particularly needless given that the entire outer surface is analysed by the two optical analysis work stations 40, 41 located upstream and downstream of the turning zone 35. The optical analysis work stations 40, 41 may be the subject of a large number of embodiment variants, and can be configured for example as per FR 2874424 and/or FR 2795499 or the like. There is also nothing to prevent other product analysis work stations, e.g. a weighing device, from being provided upstream and/or downstream of the turning zone 35.

The tilting levers 19, 21 of the two series of levers are able to grip the products therebetween in order to turn them over. The shape of the different tilting levers 19, 21 and the arrangement of the different ramps 33, 34, 37, 38 can be adapted to allow the products to be held in an extremely precise and sufficient manner in the turning phase. Possibly, a certain elastic clamping of the levers 19, 21 about the products can be achieved in the gripping position for the products (FIG. 4) depending upon the relative positions of the ramps 33, 38 and the fingers 26 and the heels 36 of the levers 19, 21. The levers 19, 21 can even be more or less flexionally elastic in order to permit such elastic clamping.

After the turning zone 35, the tilting levers 19, 21 are driven in a continuous loop, in their support position, by the belts 12, 13 so as to return to upstream of the turning zone 35.

The return conveyor 11 can be supplied with products upstream of the return zone 35 in any suitable manner It should be noted that this supply does not particularly need to be synchronised with the movement of the return conveyor 11 and can be effected transversely on the side thereof, e.g. by a simple chute or by a gripping robot or any other suitable means.

An optical analysis device in accordance with the invention can be incorporated in a device for automatically sorting and conveying the products, further comprising a device for sorting the products in accordance with predetermined selection criteria and based on signals output by the device for optical analysis of the products in accordance with the invention. Such a device for automatically sorting and conveying products comprises at least one computer control unit receiving the signals from the notably optical analysis device and controlling the tilting and unloading of the products in the appropriate unloading and sorting zones (e.g. hydraulic channels) in a manner known per se.

In the embodiment illustrated in the figures, the products are taken up, downstream of the turning zone 35, by a sorting conveyor 44 having conveying fingers, as described for example in EP 0810963 (or U.S. Pat. No. 5,998,754). It should be noted that the turning conveyor 11 does not need to be driven at precisely the same speed as that of the sorting conveyor 44. It is sufficient, in fact, if the pitch of the sorting conveyor 44 and that of the levers 19 of the second series 20 of the turning conveyor 11 allows the levers 19 of the second series 20 of the turning conveyor 11 to be nested between the conveying fingers of the sorting conveyor 44.

In a variant which is not shown, there is nothing to prevent the second levers 21 of the second series 20 of levers from being used as tilting conveying fingers for sorting the products in unloading zones located downstream of the turning zone 35. Therefore, the sorting device in accordance with the invention can comprise a single conveyor transporting the products in the longitudinal direction comprising two series of tilting levers allowing the upstream analysis of the products (optical, weighing, size, . . . ) with at least one turning zone, and the downstream sorting by unloading in unloading zones such as hydraulic channels or conveyors in accordance with the predetermined sorting criteria. There is nothing to prevent several turning zones from being provided along the conveyor, i.e. for the products to be turned over several times (in accordance with the requirements of the analyses to be carried out).

In the illustrated embodiment, the ramps 33, 34, 37, 38 form a device for controlling the tilting of the tilting levers. In a variant which is not shown, there is nothing to prevent at least one part of the ramps from being replaced with another type of device for controlling the tilting. For example, each tilting lever of at least one of the two series can be coupled to an individual tilting actuator (electric motor, electromagnet, pneumatic actuator, hydraulic actuator . . . ), this latter being controlled in at least one direction of rotation (or in both directions of rotation) by the central computer control unit. The tilting movement in at least one direction of rotation can be provided by an individual elastic return member (e.g. a helical spring) coupled to each tilting lever. Such a device for unilateral analysis—notably optical—of products in accordance with the invention thus comprises at least one imaging device located upstream of the turning zone 35 and suitable for taking an image of products borne by the first tilting levers 19 of the first series 18 of tilting levers, allowing the computer control unit to determine and identify the number of tilting levers 19 bearing each product and to control the appropriate levers (at least two per series and per product) by tilting them to turn over the product. In the case of an optical analysis, said first optical analysis work station 40 can be used as an imaging device.

In a variant which is not shown, there is nothing to prevent the first levers 19 and the second levers 21 from not belonging to one and the same turning conveyor 11 but to two separate conveyors driven in parallel one next to the other at least in the turning zone 35. Therefore, an optical analysis device in accordance with the invention comprises in any case at least one device for continuously conveying products in the longitudinal direction with respect to the structures 30.

More generally, the invention may be the subject of numerous variants and embodiments other than those described above and illustrated in the figures, whether with respect to the driving of the products, the analysis thereof, the shape and the control of the turning levers . . . For example, the tilting levers of one same series may not be articulated individually or by groups on the successive supports but may all be borne by one same flexible strip arranged to allow the tilting of levers in the manner of a caterpillar track. The tilting levers and such a flexible strip may be formed from one and the same piece (continuous strip) cut laterally to form the tilting levers.

The number and type of analysis work stations can vary. For example, the conveyor 11 with tilting levers can comprise a weighing work station allowing the products borne by the tilting levers (of the first series and/or second series) to be weighed.

The invention can likewise be the subject of many different applications, in particular for the automatic sorting of fragile fruit or vegetables such as pears or other products for which the same problems arise. It is applied more generally to any product, including elongate products (for example which can have a length ten times greater than their smallest dimension) and/or products which are not fragile.

1. A device for unilateral analysis of products comprising a product turning device comprising two series (18, 20) of tilting levers (19, 21) in opposition borne by at least one conveyor (11) driven in a longitudinal direction with respect to a fixed structure (30), and a device (33, 34, 37, 38) for controlling the tilting of the levers arranged to cause the products to be turned over in a turning zone (35) between two successive unilateral analysis work stations (40, 41) in the longitudinal direction,
wherein the tilting levers (19, 21) of each series (18, 20) are arranged with respect to each other such that in the turning zone (35) several tilting levers (19, 21) of one same series (18, 20) are caused to tilt by the control device, each product being able to be turned over under the effect of the tilting of several tilting levers of each series, and the device (33, 34, 37, 38) for controlling the tilting is arranged to cause progressive tilting of the tilting levers (19, 21) of each series (18, 20), at least in a turning direction of a product.

2. A device according to claim 1, wherein the tilting levers (19, 21) of each series (18, 20) are arranged with respect to each other such that each product can be supported by several tilting levers of one same series, said levers being successive in the longitudinal direction.

3. A device according to claim 1, wherein the tilting levers (19, 21) of each series (18, 20) are articulated in articulation axes (22) oriented in the turning zone (35) in parallel with the longitudinal direction.

4. A device according to claim 1, wherein the tilting levers (19, 21) of each series (18, 20) are articulated in articulation axes (22) which are coincident with each other in the turning zone (35).

5. A device according to claim 1, wherein the tilting levers (19, 21) of the two series (18, 20) are articulated on common supports (15) of one same conveyor (11) bearing and driving the two series (18, 20) of tilting levers.

6. A device according to claim 1, wherein the tilting levers (19, 21) of the two series (18, 20) are articulated in articulation axes (22) which are coincident with each other in the turning zone (35).

7. A device according to claim 1, wherein each conveyor (11) is continuously driven with respect to the fixed structure (30).

8. A device according to claim 1, wherein the progressive tilting of the tilting levers (19, 21) is ensured by ramps (33, 34) of the device for controlling the tilting fixed to the structure (30) and cooperating with each of the tilting levers (19, 21) successively during their movement in the longitudinal direction.

9. A device according to claim 1, wherein each tilting lever (19, 21) forms a transverse support finger (26) for the products.

10. A device according to claim 1, wherein each tilting lever (19, 21) comprises:
a transverse finger (26) having an upper support face (27) for the products and a lower face (28) cooperating with a ramp, named a turning/gripping ramp (33, 34) of the device for controlling the tilting, said lower face and said turning/gripping ramp being arranged to lift and tilt said transverse finger—during the longitudinal movement of the lever in the turning zone (35)—from a support position for the products to a turning/gripping position for the products,
and a heel (36) cooperating with a ramp, named an opening/turning ramp (37, 38) of the device for controlling the tilting, the heel (36) and said opening/turning ramp being arranged to lift and tilt said transverse finger (26)—during the longitudinal movement of the lever in the turning zone (35)
from a turning/gripping position for the products to a support position for the products.

11. A device according to claim 1, wherein, at least in the turning zone (35), the tilting levers (19, 21) form the only members for transporting the products.

12. A device for automatically sorting and conveying products comprising a device for unilateral analysis of the products and a device for sorting the products in accordance with predetermined selection criteria and based on signals output by the device for unilateral analysis of the products, characterised in that it comprises a device for unilateral analysis of the products according to claim 1.
